(19) United States
(12) Patent Application Publication
(10) Pub. No.: US 2006/0055811 A1
(43) Pub. Date: Mar. 16, 2006

(54) Imaging system having modules with adaptive optical elements

(76) Inventors: Bernard S. Frtiz, Eagan, MN (US); James A. Cox, New Brighton, MN (US); Roland A. Wood, Bloomington, MN (US); Thomas R. Ohnstein, Roseville, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/940,308

(22) Filed: Sep. 14, 2004

(51) Int. Cl. H04N 5/225

(52) U.S. Cl. 348/340; 348/207.11

(57) ABSTRACT

A compound sensor imaging system having lenses moveable relative to one another and their respective detectors. The movement may be controlled by a computer. The patterns of movement may be provided by algorithms. The system may have numerous optical units or modules. Each module may have a lens and a sub-array of one or more detectors. There may be barriers between adjacent modules to reduce cross-talk. The lenses, barriers and detector sub-arrays may be of arrays aligned with one another and fabricated together as an assembly.

### BACKGROUND

The present invention pertains to image sensors and particularly to systems having compound-eye imaging. More particularly, the invention pertains to systems having distributed sensing modules.

Compound-eye imaging is an idea that was noted by observing an insect's perception system such as that of a dragonfly. Attempts to emulate such a system have been discussed in the related art. Moving optics relative to a base structure has been discussed in U.S. Pat. No. 6,445,514 B1, issued Sep. 3, 2002, with inventors T. Ohnstein et al., and entitled “Micro-Positioning Optical Element”, which is incorporated herein by reference in its entirety.

### SUMMARY

The present invention involves a system that somewhat emulates a multiple-imaging concept, to the extent that it may be known, of certain insects' compound eyes. Such an imaging system may be described along with certain improvements and refinements of the optics, detection and processing.

### BRIEF DESCRIPTION OF THE DRAWINGS

FIG. 1 shows a diagram of a compound imaging system;

FIG. 2 shows the signals of sampled parts of an object by photo cells and the parts constituting the whole image of an observed object;

FIG. 3 shows an imaging system having arrays of microlenses, baffles and detectors;

FIG. 4 shows a side view of three units of an imaging system;

FIG. 5 shows a table of characteristic parameters of an imaging system;

FIG. 6 illustrates cross-talk between sensing units;

FIG. 7 is an example of a wall structure for optically isolating sensing units from one another;

FIG. 8 is an example of a polarizer structure for optically isolating sensing units from one another;

FIG. 9 shows a field-of-view of a multiple sensor imaging system with lenses;

FIG. 10 shows a filed-of-view of a multiple sensor imaging sensor with lenses and deflectors;

FIG. 11 shows a one-dimensional model of an optical system;

FIG. 12 is a diagram of a form of the equations used for the system of FIG. 11;

FIG. 13 is a singular matrix with eigenvalues for model analysis of an optical imaging system;

FIG. 14 may be an inverse matrix of the matrix in FIG. 13;

FIG. 15 is a schematic diagram of a positioning system for an optical element;

FIG. 16 is a perspective diagram of an imaging system with numerous sensing modules;

FIG. 17 is a block diagram of an imaging system and computer; and

FIG. 18 is an illustration of a number of lens positions relative to a detector array providing images for the various positions of the lens to be processed into a resultant image.

### DESCRIPTION

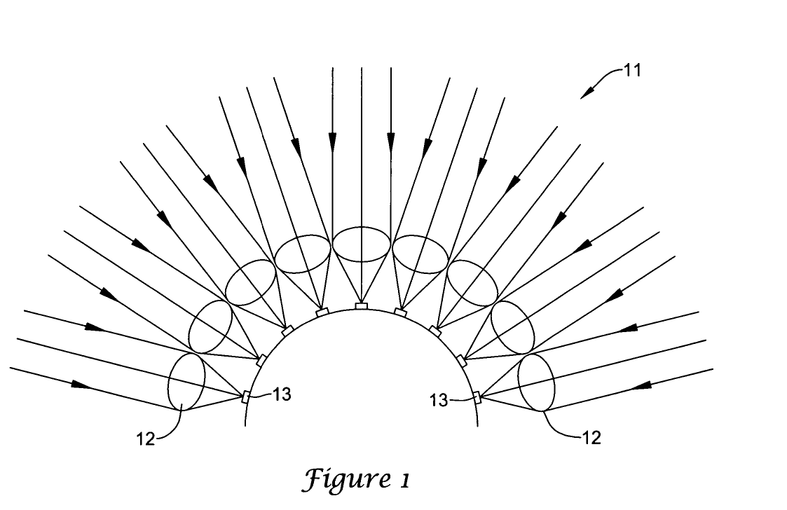

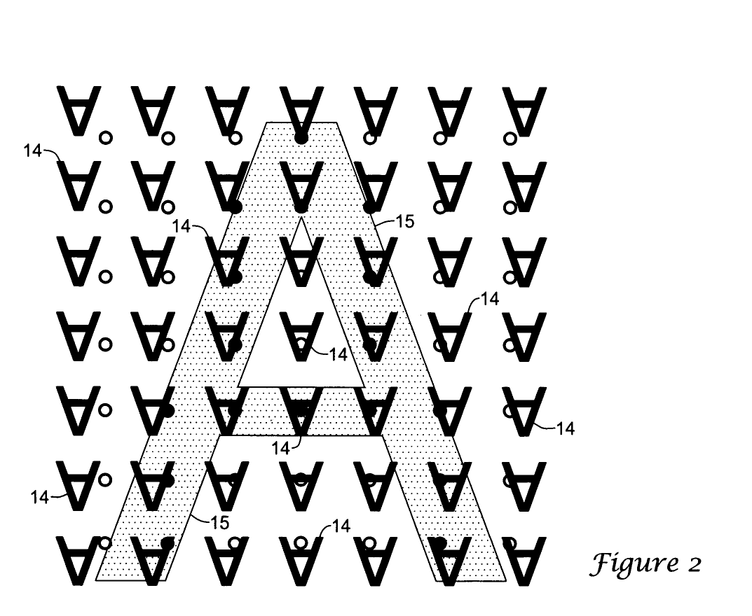

The present system may have similarities relative to a compound-eye imaging system. Such a compact imaging system may be developed with various improvements. The number of pixels of a captured image may be equal to that of a compound eye. FIG. 1 shows a sketch of a compound eye imaging system 11. It may have an optical system with multiple sets of elemental optics (viz., units), each of which has a microlens 12 and a photosensitive cell 13. An object being viewed may be imaged onto the photosensitive cell 13 by each microlens 12. The photo signal at a specific position may be sampled and detected by the cell 13. While adjacent units focus on similar images on a surface, different parts of the object 15 may be sampled by the cells 13 due to a geometrical relationship between the object 15 and respective unit. As a result, a set of signals 14 detected by all of the units may constitute a whole image of the object 15, as illustrated in FIG. 2. The reconstructed image is an erect one and that its number of pixels may be the same as the number of units.

Simple manipulation may be achieved by changing the position of each photosensitive cell 13. For an erect image, the photosensitive cell 13 may be set at the optical axis of each unit. If cell position is changed according to a specific rule, then reduction, magnification or rotation of the object 15 image may be achieved.

A significant feature of the compound eye's imaging system 11 may be its applicability to a wide-field-of-view (i.e., up to 360 degrees) optical system. For such system as a single-eye system, a very large lens would likely be required. This kind of lens would be prone to cause aberrations. In view of this disadvantage, a moving mechanism equipped with a single-eye imaging system with a narrow-filed-of-view may be used. However, a method to control movement may be required, adding to the complexity of an imaging system.

An issue with the compound-eye imaging system 11 is that a small number of units may result in a degradation of image quality. Further, only part of an incident optical signal may be detected by the photosensitive cell, thus resulting in a low light efficiency of the system.

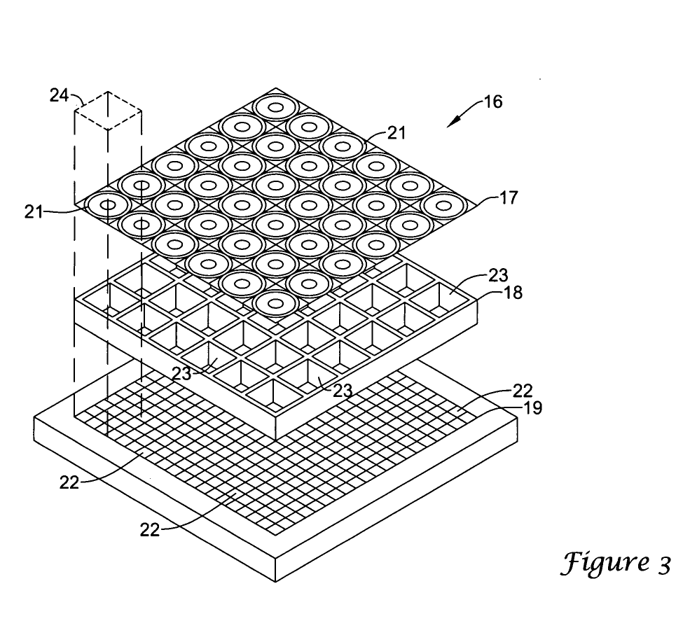

FIG. 3 shows an imaging system 16 having a microlens array 17, a separation array 18 and a photodetector array 19. Each microlens 21 may send optical signals to multiple photosensitive cells 22 on the photodetector array 19. Adjacent units 24 may be separated by an opaque wall 23 to prevent cross talk. A CCD chip or complementary metal-oxide semiconductor (MOS) sensor chip may be used for the photodetector array 19.

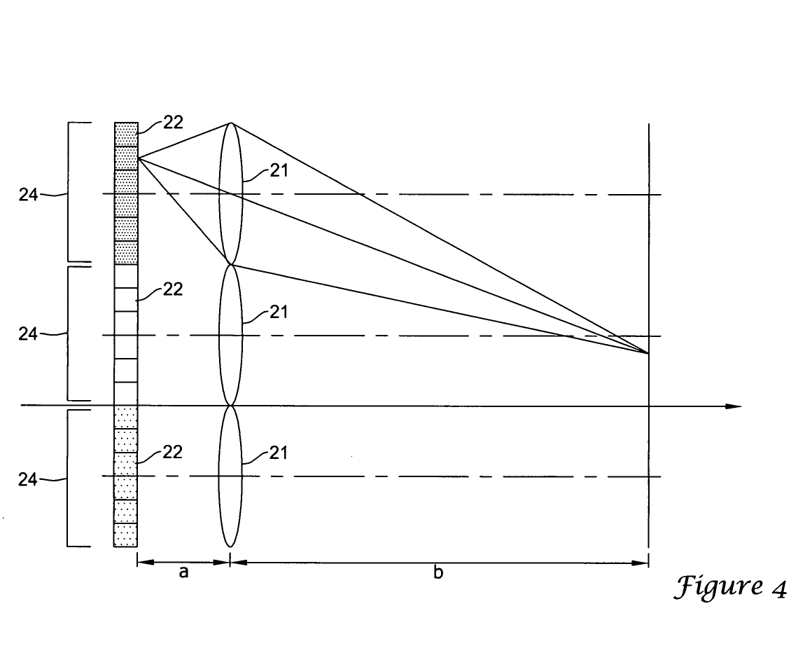

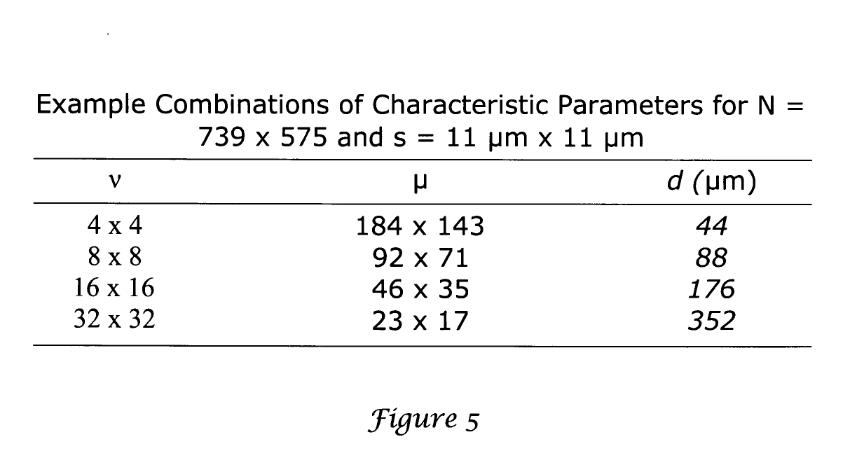

FIG. 4 shows a side view of an optical system. The system may be characterized by a unit 24 number μ, a unit width d, and a number of photosensitive cells 22 per unit, ν. For a photo detector array 19 having N pixels and a pixel width s, the following equations may be satisfied.
N=μν
s=d/ν
The proportion of characteristic parameters may be arbitrary. FIG. 5 is a table of examples of characteristic parameters for a charge-coupled device (CCD) imaging system having N=739×575 and s=11 μm×11 μm. A native compound-eye imaging system may correspond to ν=1 and μ=N.

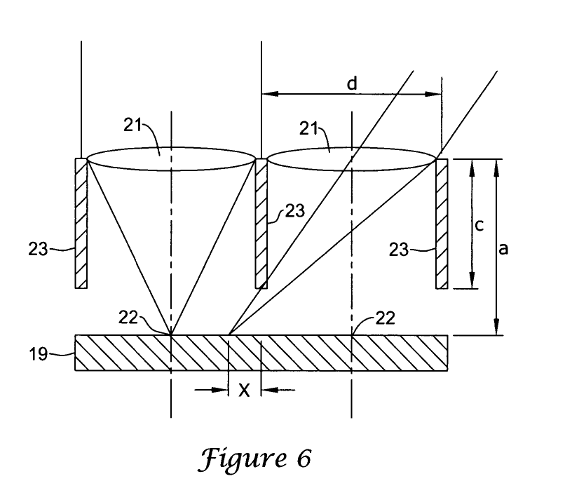

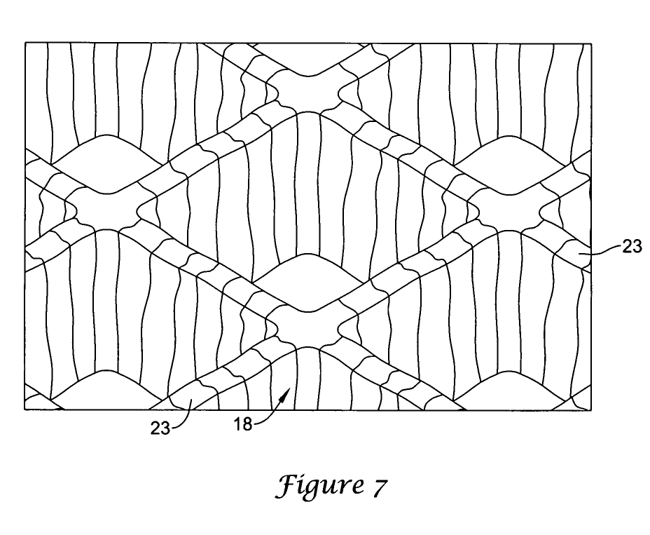

Optical signal crosstalk between adjacent units 24 may be a detriment in image detection. To reduce crosstalk, a separation layer or wall 18 may be inserted between the microlens array 17 and photodetector array 19. Even thought a full-height wall 23 that touches both arrays is good, a partial wall 23 may be sufficient in reducing crosstalk. FIG. 6 shows a cross section of a partial wall between the arrays. A width x of the maximum area affected by crosstalk may be determined by

$$x = \frac{( a - c ) d}{zc} ,$$

where the distance between the microlens 21 and the photodetector 22, unit 24 width and wall 23 height are a, d and c. respectively. The separation layer 18 may also be a structural frame for the imaging system 16. An example of the wall or baffle structure 18 for blocking light from other sensing units 24 is shown in FIG. 7.

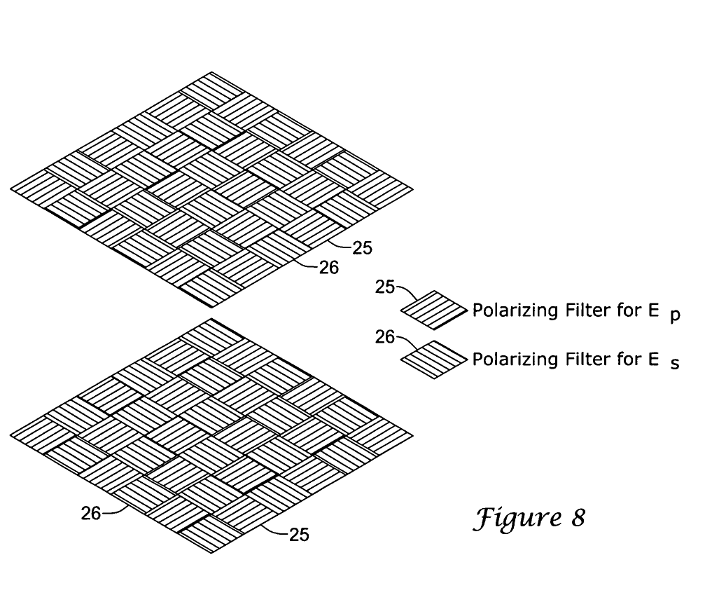

Polarizers may be used for reducing crosstalk between units 24. FIG. 8 shows a layout of polarizers 25 and 26 each having orthogonal orientations relative to adjacent polarizers. Polarizer 25 may be a filter for Eₚ. Polarizer 26 may be a filter for Eₛ. The polarizers may be set at the microlens array 17 and at the photodetector array 19. Each unit 24 then may detect one of the orthogonal polarizations. This approach may also be used for polarization sensitive sensing.

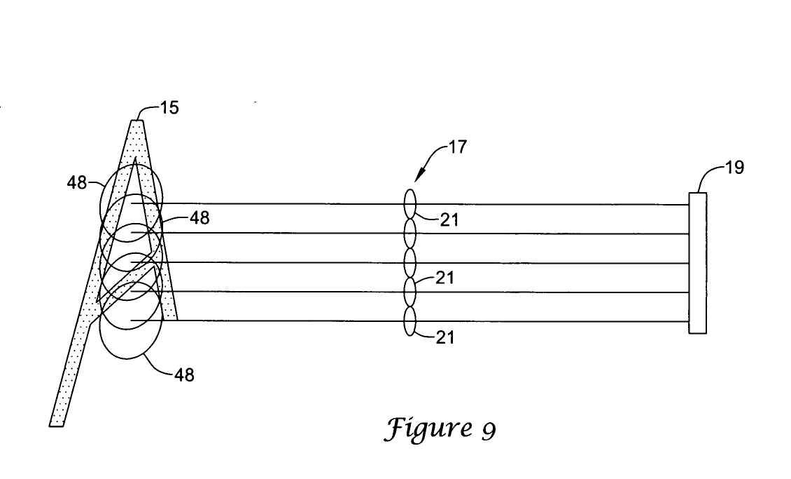

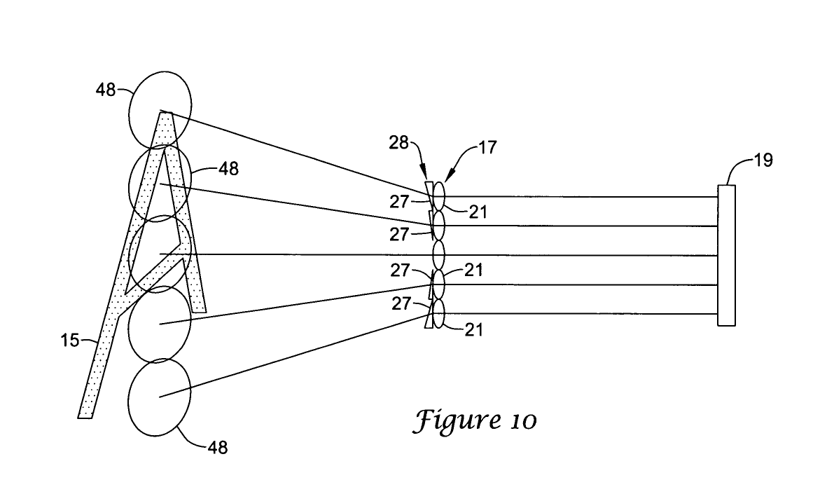

When an object 15 is situated close to an imaging system, the field of view of the system may be limited, as in FIG. 9. FIG. 10 shows how the field of view may be extended with an array of deflective elements 27, e.g., a prismlet array 28. A concave lens in front of the lens array 17 may extend the field of view. A practical way to extend the field of view may be to use a diffractive lens accompanied by a beam steering effect.

When the viewed object 15 is located an infinite distance from the system, all units 24 may observe the identical image. This approach may result in a degradation of the observed image. So the above approach may be useful for solving this problem.

Images of objects 15 from signals captured by multiple units 24 may be retrieved with sampling or backprojection. An image of the compound-eye system may have a set of signals sampled at specific points in the individual units. The sampling may be obtained by selecting a signal at a detector element 21 of the photodetector array 17. For observation of an object 15 located a short distance from the system, the signals at the optical axis of individual units 24 may produce an erect image, as shown in FIG. 2. The sampling points may be changed to transform the sensed image by reduction, magnification, rotation and so forth.

For sampling, the number of pixels of a retrieved image may be determined by the unit number μ. Increasing the unit number is significant for high-resolution imaging. A configuration with a small ν, i.e., a small number of sensors or photosensitive cells 22 per unit 24, may relax the fabrication conditions, with the penalty of less functionability.

The other retrieval approach may be back projection. To increase the quality of reconstructed images, signals captured by the photodetector array 19 may be utilized in processing. From the relationship between the elements on an object 15 and the photodetector 22, the object image may be calculated from the captured signals.

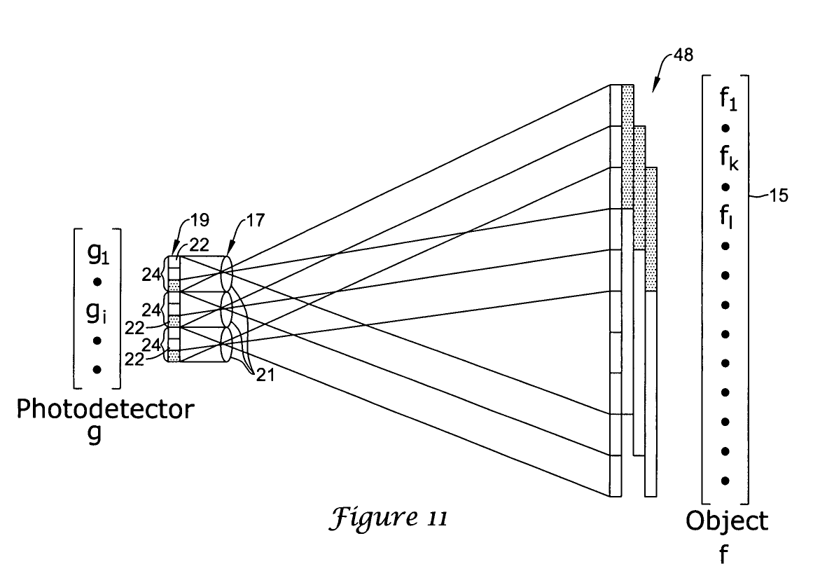

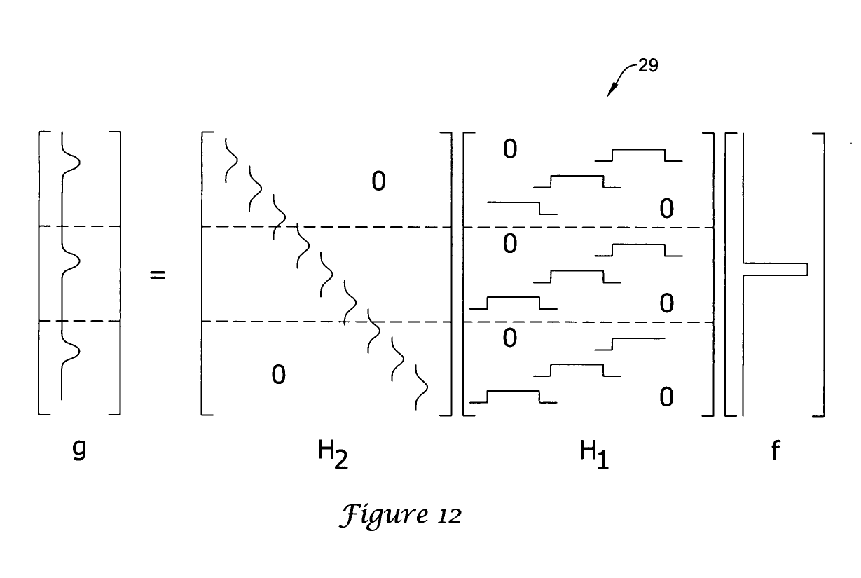

The optical system of a one-dimensional model may be considered. The model may have vectors f and g and matrix H, where f and g are elements of the object 15 and signals at the photodetector 22, respectively. H may denote a system matrix. The system may be described as
g=Hf
Looking at FIG. 11 and considering the point system of each unit 24, the system matrix may be described with the following form,
H=H₂H₁,
where H₁ is image duplication with demagnification and H₂ is the point-spread function of the imaging units 24. A form of the two preceding equations for μ=3 and ν=3 is shown as a schematic in FIG. 12. H₁ may be identified from system parameters. H₂ may be calculated from appropriate assumptions or it may be determined by an experimental measurement with the same condition as usage.

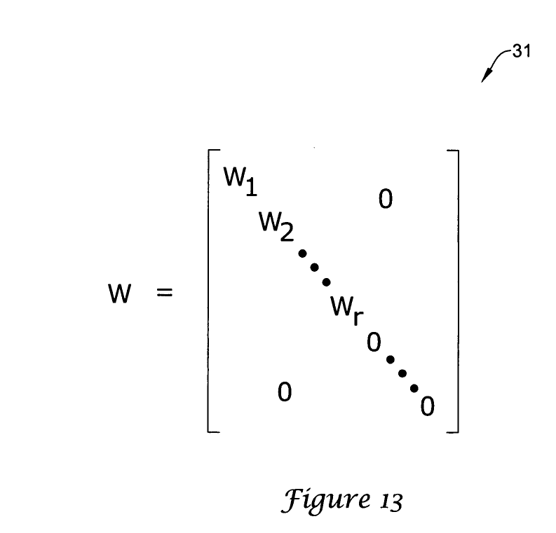

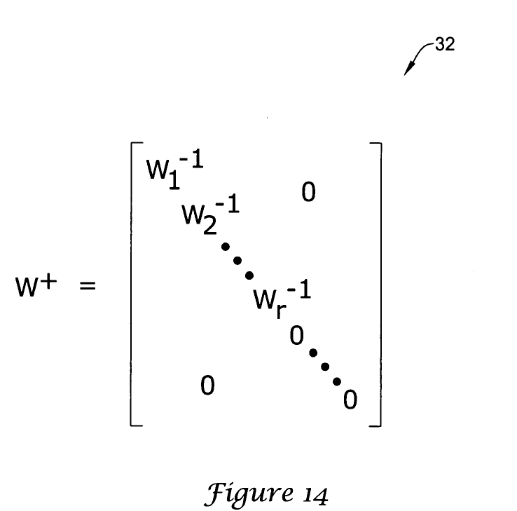

In general, H is not necessarily a regular matrix, so some mathematical techniques may be used to solve “g=Hf”. A singular-valve decomposition method may be used to obtain a pseudoinverse matrix H⁺. In this approach, the least-mean-squares criterion may be adopted. The system matrix H may be decomposed by use of singular valves as follows,
H=VWU^{T},
where U and V are matrices composed of the eigenvectors of HH^{T} and H^{T}H, respectively. The superscript T is a transpose operator. W may be a singular matrix that has eigenvalues wᵢ (wᵢ>w₂> . . . >wᵣ) as the diagonal components of a matrix 31 shown in FIG. 13. In a practical calculation, the eigenvalues with small values may be truncated to suppress noise amplification. Thus, the ratio of wᵢ/wᵣ may be treated as a control parameter of the retrieval process. Pseudo-inverse matrix H⁺ may be obtained as follows,
H⁺=VW⁺U^{T},
where W⁺ is equal to a matrix 32 shown in FIG. 14. Consequently, the object 15 image may be retrieved by the following equation,
f=H⁺g.
For a two-dimensional system, vectors f and g and matrix H may become matrices and a tensor. The procedure may be the same as for the one-dimensional case described above.

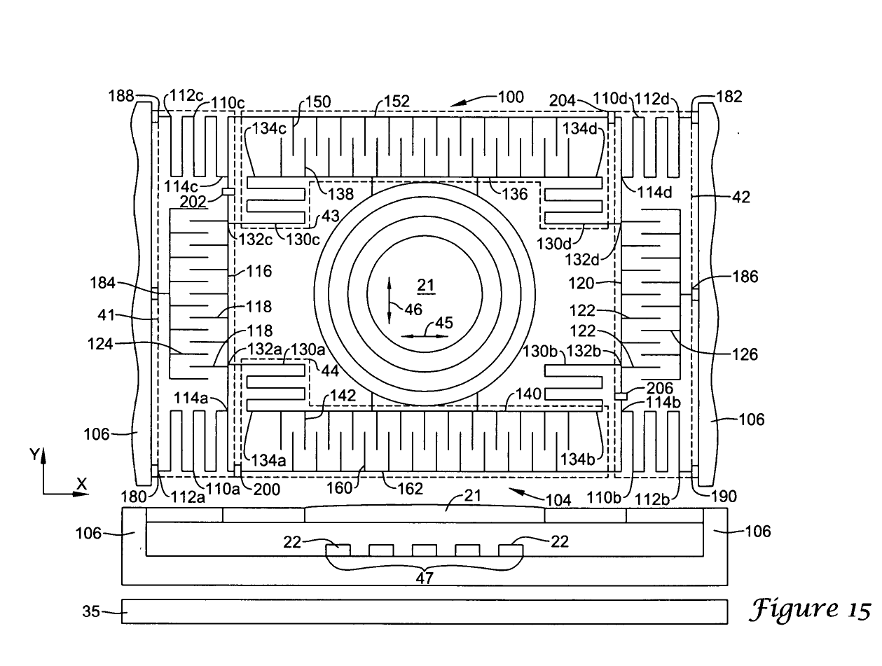

The above noted imaging system may be improved with respect to the fixed micro-optics. First, a microlens 21 in a module, which performs beam steering by having a fixed lateral displacement of the microlens 21, may be incorporated, as in FIG. 15. FIG. 15 is a schematic diagram of a micro-positioning system 100 that provides independent control of an optical device 21 in both the X and Y direction. Independent movement of the optical element may be achieved by providing a carrier or frame 104 that is spaced above a base 106. The carrier 104 may be operatively coupled to the base 106 such that the carrier 104 can be selectively moved in the X direction but not substantially in the Y direction. This is may be accomplished by coupling the carrier 104 to the base 106 with, for example, four folded beam or serpentine springs 110a, 110b, 110c and 110d. One end (i.e., 112a, 112b, 112c and 112d) of each serpentine spring 110a, 110b, 110c and 110d may be anchored to the base 106, and the other end (i.e., 114a, 114b, 114c and 114d) may be anchored to the carrier 104. The serpentine springs 110a, 110b, 110c and 110d may be designed such that they substantially prevent movement of the carrier 104 out of the plane of the structure and substantially prevent movement in the in-plane Y direction. Thus, the carrier 104 may move substantially only along the X direction.

The left side 116 of the carrier 104 may include a number of comb fingers, such as a comb finger 118, which extend to the left. Likewise, the right side 120 of the carrier 104 may include a number of comb fingers, such as a comb finger 122, which extend to the right. Each of the comb fingers 118 and 122 may be fixed to the carrier 104, and integrally formed with the carrier 104.

Extending from the left, a number of comb fingers, such as comb finger 124, may extend to the right and be inter-digitated with the left comb fingers 118 of the carrier 104. Likewise, extending from the right, a number of comb fingers, such as comb finger 126, may extend to the left and be inter-digitated with the right comb fingers 122 of the carrier 104. The comb fingers 124 and 126 may be fixed to the base 106.

To move the carrier 104 to the left, an X driver may provide a voltage difference between the static comb fingers 124 and the left comb fingers 118. Since comb fingers 118 may be attached to the carrier 104, the electrostatic actuation causes the carrier 118 to move to a new leftward position relative to the base. Likewise, to move the carrier 104 to the right, the X driver may provide a voltage difference between the static comb fingers 126 and the right comb fingers 122. Since comb fingers 122 may be attached to the carrier 104, the electrostatic actuation causes the carrier 118 to move to a new rightward position relative to the base. To a first order, the position of the carrier 104 may be proportional to the force, which is proportional to the square of the applied voltage.

An optical element, such as lens 21, may be operatively coupled to the carrier 104 such that the optical element 21 can be selectively moved in the Y direction relative to the carrier 104, but not substantially in the X direction. This may be accomplished by coupling the optical element 21 to the carrier 104 using, for example, four (4) serpentine springs 130a, 130b, 130c and 130d. One end (i.e., 132a, 132b, 132c and 132d) of each serpentine spring 130a, 130b, 130c and 130d may be anchored to the carrier 104, and the other end (i.e., 134a, 134b, 134c and 134d) may be anchored to the optical element 21, as shown. The serpentine springs 130a, 130b, 130c and 130d may be designed such that they substantially prevent movement of the optical element 21 out of the plane of the structure and also substantially prevent movement in the in-plane X direction. Thus, the optical element 21 may move substantially only along the Y direction relative to the carrier 104.

In an illustrative example, the optical element may include a top support bridge 136 that extends between the top serpentine springs 130a and 130b, and a bottom support bridge 140 that extends between the bottom serpentine springs 130c and 130d. The top support bridge 136 of the optical element may include a number of comb fingers, such as comb finger 138, which extend upward. Likewise, the bottom support bridge 140 of the optical element 21 may include a number of comb fingers, such as comb finger 142, which extend downward. Each of the comb fingers 138 and 142 may be fixed to the corresponding support bridge, and be integrally formed therewith.

A number of comb fingers, such as comb finger 150, may extend down from the top 152 of the carrier 104 and be inter-digitated with the comb fingers 138 that extend upward from the top support member 136 of the optical element. Likewise, a number of comb fingers, such as comb finger 160, may extend up from the bottom 162 of the carrier 104 and be inter-digitated with the comb fingers 142 that extend downward from the bottom support member 140 of the optical element.

To move the optical element 21 in an upward direction, a Y driver may provide a voltage difference between the comb fingers 150 that extend down from the top 152 of the carrier 104 and the comb fingers 138 that extend up from the top support member 136 of the optical element. The electrostatic actuation may cause the optical element 21 to move to a new upward position relative to the carrier 104. Likewise, to move the optical element 21 in a downward direction, the Y driver may provide a voltage difference between the comb fingers 160 that extend up from the bottom 162 of the carrier 104 and the comb fingers 142 that extend down from the bottom support member 140 of the optical element. The electrostatic actuation may cause the optical element 21 to move to a new downward position relative to the carrier 104. To a first order, the position of the optical element 21 relative to the carrier 104 may be proportional to the force, which is proportional to the square of the applied voltage.

The carrier 104, serpentine springs 110a, 110b, 110c and 110d and 130a, 130b, 130c and 130d, comb fingers 118, 122, 124, 126, 138, 142, 150 and 160, and top and bottom support bridges 136 and 140 may be patterned from a single doped silicon layer. To help deliver an appropriate voltage to the various elements of the micro-positioning system 100, metal traces may be provided on top of the silicon layer to the connecting terminals of the micro-positioning system, 180 to 190. These metal traces may be electrically isolated from the silicon layer by providing a dielectric layer between the silicon layer and the metal traces.

In one illustrative example, metal traces may be connected to the silicon layer at the ground terminals 180 and 182. This effectively connects to a ground, various parts of the micro-positioning system, through the silicon layer, from the ground terminal 180, along serpentine spring 110a, up the left side 116 of carrier 104, along serpentine springs 130a and 130c, then down the top and bottom support bridges 136 and 140, along serpentine springs 130b and 130d, and down the right side 120 of the carrier 104. The connection may also continue across serpentine spring 110d to ground terminal 182. Another metal trace may electrically connect to the silicon layer at the X-NEG terminal 184 and to comb fingers 124 through the silicon layer. Yet another metal trace may electrically connect to the silicon layer at the X-POS terminal 186 and to comb fingers 126 through the silicon layer. Another metal trace may connect to the silicon layer at the Y-POS terminal 188, and connect with serpentine spring 110c, down the top 152 of the carrier 104, and finally to comb fingers 150, through the silicon layer. Finally, another metal trace may connect to the silicon layer at the Y-negative terminal 190, and connect with serpentine spring 110b, down the bottom 162 of the carrier 104, and finally to comb fingers 160, through the silicon layer.

To provide electrical isolation between the various parts of the micro-positioning structure, a number of isolation members may be provided. For example, an isolation member 200 may be used to electrically isolate the bottom 162 of the carrier 104 from the left side 116 of the carrier 104. Likewise, an isolation member 202 may be used to electrically isolate the left side 116 of the carrier 104 from the top 152 of the carrier 104. Yet another isolation member 204 may be used to electrically isolate the top side 152 of the carrier 104 from the right side 120 of the carrier 104. Finally, an isolation member 206 may be used to electrically isolate the right side 120 of the carrier 104 from the bottom 156 of the carrier 104. It may be recognized that the connecting terminals 180-190 and the various exterior combs 124 and 126 should be isolated from one another, particularly if they are all formed using the same top silicon layer. Such isolation may be accomplished in any number of ways including, for example, using trench isolation techniques.

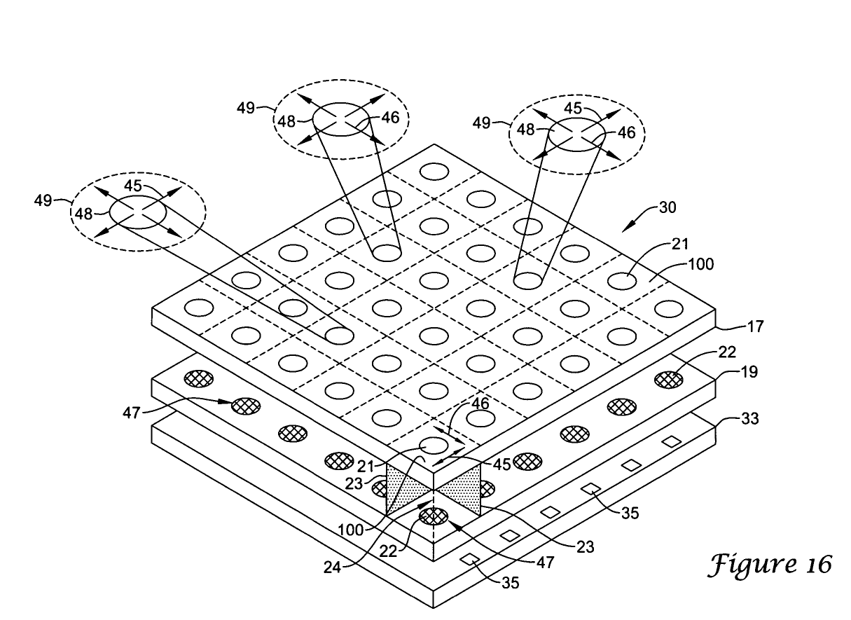

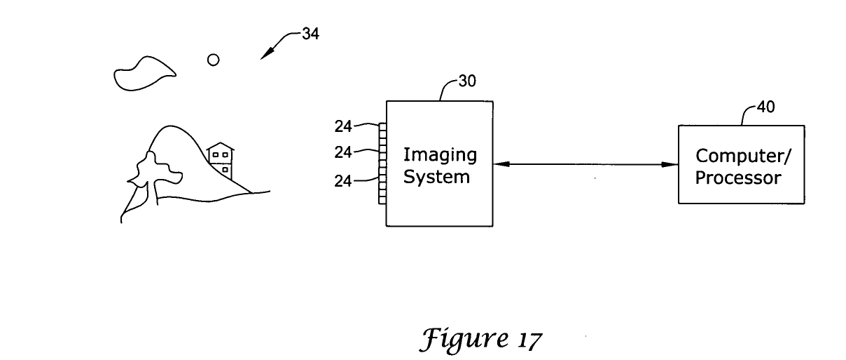

FIG. 16 shows a system 30 having an array 19 of a number of sub-arrays 47. Each sub-array 47 may have a number of detectors 22. Detectors 22 may be CCD or microbolometers as illustrative examples. The detectors 22 may sense infrared or visible light. Detectors 22 may sense other wavelengths and be of other technologies. There may be one sub-array for each imaging module or unit 24. The magnitudes of the lens 21 displacements may vary among the modules or units 24, but the displacements may be fixed for any given module 24. The construction approach in which the two-dimensional array of modules 24 is fabricated may incorporate MEMS techniques. The optical assembly, i.e., lenses, gratings, prisms, and so forth, may be reconfigurable in a controllable manner by the use of MEMS (viz., micro electro-mechanical systems) built comb drives or actuators 41, 42, 43 and 44, as each lens 21 position system 100 may be independently reconfigured under processor 40 control for changing conditions. Actuators 41 and 42 may provide plus or minus X direction movement 45. Actuators 43 and 44 may provide plus or minus Y direction movement 46. Controlling factors may include varying or moving the field-of-view 48 and resolution. These may be useful as the distance between the optics including micro lens 21 and an observed scene 34 changes. Movement of the lens 21 with the position adjusting device or mechanism 100 may shift, move or vary the field-of-view 48. The shift or movement may be in directions 45 and/or 46. The limits of movement may be set at a boundary 49. The shown fields-of-view 48 in FIG. 16 are illustrative examples, although all of the modules or units 24 of system 30 may have adjustable fields-of-views 48. The lens 21 not only may be moveable laterally but also moveable vertically relative to the detector sub-array 47. The lens 21 may also be tilted relative to the detector sub-array 47. Also, lenses 21 may be substituted with an overall lens (not shown). FIG. 17 is a block diagram of system 30 and computer 40 with the observed scene 34.

Reconfigurable optics 21 with the positioning device 100 may address the issue of misalignment of components by implementing the optics 21 and detector 22 alignment. Particularly, the micro-optics may be an array 17 of silicon micro-lenses 21 integrated with MEMS actuators for lateral translation. Limitations of resolution caused by aberrations and diffraction of microlenses may be improved by using aspheric elements and hybrid refractive diffractive lens assemblies in the micro-optics 21. Aspheric elements may have a discontinuous conic shape. The shape of the element or lens 21 may be designed and matched to reduce spherical aberration that may be present with spherical elements. The shape of the lens or element may be custom designed with a surface that is altered from a spherical one to reduce aberrations. Aspheric optical elements may be fabricated with laser writing and molding or ink-jetting with a gradient index, for example. This approach may permit the use of higher numerical aperture (NA) optics and thus reduce diffractive limitations.

Signal crosstalk between modules may be reduced with greater intermodule separation. This separation may be achieved with the design flexibility from the lateral displacement of the module optics. MEMS or micromachined baffles 23 may be used between the micro-optics 21 and detectors 22 in each module or unit 24 to achieve further reduction in optical crosstalk if the intermodule separation is small. FIG. 16 shows two illustrative baffles 23 for one of the modules or units 24. The baffle array 18 as shown in FIGS. 3 and 4 may be placed between arrays 17 and 19 of system 30 for the separating of all of the modules or units 24 in the system. An array 18 having partial baffles or walls 23 may be placed between arrays 17 and 19 as shown in FIG. 6.

Signal distortion caused by the electronics is not a fundamental limitation and may be minimized with improved read-out electronics ASIC chips 35 in array 33 of system 30. The wavelength range of operation of the imaging system 30 may be extended to the infrared range with the use of infrared sensors, particularly uncooled infrared sensors, as detectors 22 of array 19 of system 30. There may be a number of detectors 22 for each module or unit 24 and that number may consist of the same kind of detectors or a combination of different detectors such as visible, infrared and ultra-violet detectors as an illustrative example.

There is no clear limitation or restriction on the geometry of the two-dimensional array of modules 24 except that such geometry is known to the processor of the imaging system. Thus, the modules may be placed on a regular rectangular grid as shown as an illustrative example in FIG. 16. Alternatively, the modules 24 may be placed on a regular hexagonal grid or a completely random grid on a plane. Any of these grids may be on a flat surface or on a non-flat surface such as a curved surface.

There is no limitation or restriction on the electronic readout of array 33 and signal conditioning circuitry in chips 35 and/or computer 40 used relative to the signals from the photodetectors 22 in each module 24. These and any other approaches may be incorporated for visible, infrared detector, ultra-violet, or other bandwidth arrays 19 of the imaging system 30. The underlying detector array 19 may be a silicon array.

There may be a two-dimensional array of modules 24. Each module 24 may have a reconfigurable optical apparatus 101, an underlying array 19 of photodetectors 22 with appropriate electronics 35, and hardware and software of computer 40 and chips 35 to process photodetector signals so as to produce a high quality image of a scene 34. A reconfigurable optical apparatus may mean an optical apparatus 101 whose optical influence on the underlying array 19 of photodetectors 22 within any module 24 may be changed at will in a controllable manner. In particular, the optical apparatus 101 may include a microlens 21 whose lateral position relative to the optical axis of the module 24 may be changed at will in a controlled manner. The optical apparatus 101 may include a lens assembly. The lens assembly may have refractive, reflective, or diffractive optical elements, or various combinations of these optical elements. The optical apparatus may incorporate baffles 23 to suppress stray light or radiation from external sources nearby the apparatus or from another optical apparatus. The baffles 23 may be produced with MEMS fabrication techniques.

The photodetector array 19 may have visible or infrared detectors 22. The array may have a combination of detectors 22 with different bandwidth sensitivities. The infrared detectors may be uncooled detectors. The photodetector array 19 may even have a single detector. The detector may sense visible or infrared light. Or it may sense other bandwidths of radiation. The infrared detector here may be uncooled.

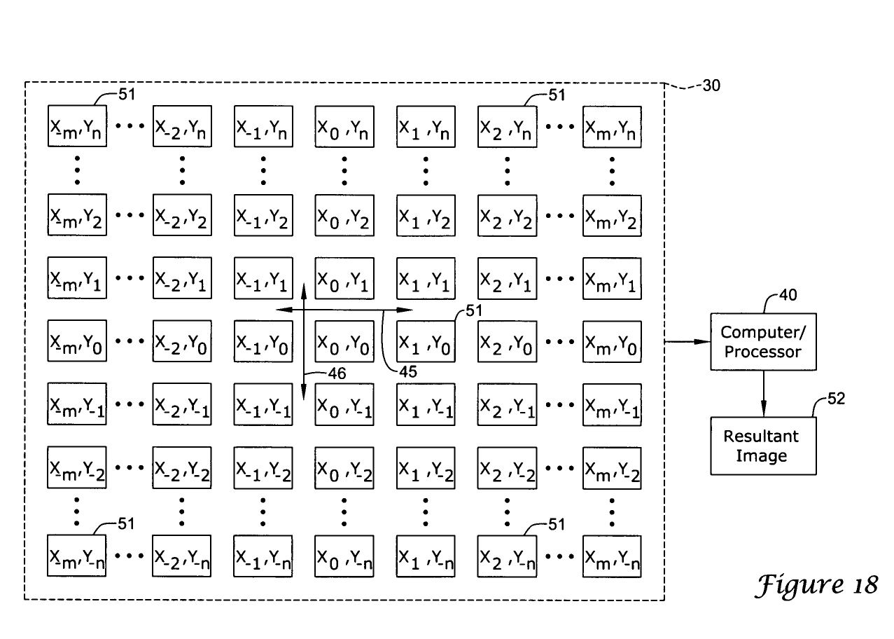

The sensing system 100 may have a lens 21 and a set number of lateral positions for imaging. Lens 21 may move or be positioned in direction 45 (xₙ) of 25 positions to the left of center position or 25 positions to the right of center position. These positions may be labeled x₋₁ to x₋₂₅ to the left and x₁ to x₂₅ to the right. Similarly the lens 21 may move or be positioned in the directions 46 (yₙ) of 25 positions below center position or 25 positions upward of the center position. These positions may be labeled y₋₁ to y₋₂₅ downward and y₁ to y₂₅ upward. The center position may be at a position x₀,y₀. The lens positions may have one micron increments or each of the increments may be more or less than one micron. Lens 21 may have 2601 positions and each position may have a label of (xₘ,yₙ), where m and n each may have a value from 0 to 25, plus or minus. The total number of lateral positions may be more or less than 51 for each of the directions 45 and 46. Positions for each of the images 51 for a one lens 21 unit 24 are shown in FIG. 18. Computer or processor 40 may sequence information of images 51 into a resultant image 52. The bandwidth of image information conveyance may become significantly large if a video sequence of images 52 at a 1/30th second frame rate is desired. For static images 52, of course, the bandwidth would appear to be significantly less.

There may be an array 30 of moveable lenses 21 with their respective arrays 47, as in FIG. 16. There may a parallel signal transfer of an array of units 24 but a serial signal transfer of each image 51 for each position of lens 21. A 6×6 array 30 of units 24, with corresponding lenses 21 and detector arrays 47, is shown in FIG. 16. The array 30 may have more or less than 36 units 24 for compound imaging. However, with a number of lenses 21 having a numerous positions, the resolution of imaging array 30 may be greatly increased. Theoretically, with 51 positions for each direction, 45 and 46, the resolution increase could be as great or greater than 2600 times 6×6 times the number of pixels 22 in array 47, than the resolution of a single lens 21 having one position and a one detector array 47.

If there is only one lens 21 and an array 47 of detectors 22 below the lens for receiving an image 51 of scene 34, different sets of information or variants of images 51 of scene 34 may be received. See FIG. 18. Pixels 22 and respective arrays 47 may be of CCD, microbolometer or other detector technology. These sets of images 51 may be processed by computer 40 into a resultant image 52. This image 52 may have a resolution significantly greater than a resultant image 52 processed from only one position of the lens. For instance, a resulting image 52 processed from 2601 images 51 corresponding to the respective positions could arguably have a resolution of up to 2601 times greater than a resultant image 52 resulting from only one image 51 at one lens position.

The lens 21 may be configurable to less than 2601 positions of image 51 that may be processed into a resultant image 52 of scene 34. With fewer positions, less bandwidth may be needed for conveying and processing images 51 into a resultant image 52. The arrays 47 may each have 64×64 pixels or have more or less pixels. However, pixel array 47 may be electronically scaled down to fewer pixels, e.g. 16×16 or less, or up-scaled to more pixels, e.g., 32×32, or another size, depending on the bandwidth availability and other parameters. As an illustrative example, array 47 in FIG. 15 may be a 5×5 pixel array. Each array 47 may even be scaled down to one pixel. The desired resolution of a resultant image of scene 34 may be a factor. Scene 34 may be of anything, e.g., microscopic particles, landscape or other things.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. An imaging system comprising:
an array of detectors;
a holder situated over the array;
a lateral mover mechanism connected to the holder; and
a lens situated in the holder having a focal point focused on at least one detector of the array; and
wherein the lateral mover mechanism may move the focal point on around on the array.

2. The system of claim 1, wherein movement of the focal point around the array is movement from at least one detector to another detector.

3. The system of claim 2, wherein movement of the focal point on the array is beam steering relative to a scene.

4. An imaging system comprising:
an array of sub-arrays of detectors; and
an array of lenses situated proximate to the array of sub-arrays of detectors; and wherein:
each lens of the array of lenses has a focal point situated on a respective sub-array of detectors; and
each lens is laterally moveable relative to the respective sub-array of detectors.

5. The system of claim 4, wherein the focal point of each lens is laterally moveable on the respective sub array of detectors.

6. The system of claim 5, wherein each lens is laterally moveable relative to other lenses of the array of lenses.

7. The system of claim 5, further comprising a movement actuator connected to each lens.

8. The system of claim 5, further comprising baffles between adjacent lenses.

9. The system of claim 4, further comprising an array of electronics connected to the detectors and the movement actuators.

10. The system of claim 9, further comprising a computer connected to the array of electronics.

11. The system of claim 4, wherein the lateral position of each lens may be adjusted for a particular field-of-view and resolution.

12. The system of claim 11, wherein the lateral position of each lens may be dynamically adjusted to changing scenes being viewed by the imaging system.

13. The system of claim 9, wherein a first set of signals from the array of electronics go to the computer for image composition of a scene viewed by the imaging system.

14. The system of claim 13, wherein a second set of signals go from the computer to the movement actuator via the electronics for position adjustment of each lens to determine a beam steering of the lenses.

15. The system of claim 14, wherein the computer varies and controls beam steering of the lenses.

16. The system of claim 4, wherein the lateral position of each lens is adjusted and coordinated with each other to achieve certain imaging results.

17. The system of claim 4, wherein:
the detectors are selected from a group consisting of visible detectors, infrared detectors and ultraviolet detectors; and
the lenses are selected from a group consisting of aspheric elements, spheric elements, grating elements, prism elements, refractive elements, reflective elements and diffractive elements.

18. The system of claim 17, wherein:
the infrared detectors are uncooled detectors; and
the lenses are micro-lenses.

19. The system of claim 18, wherein:
the infrared detectors are silicon microbolometers;
the lenses are silicon micro-lenses; and
portions of the imaging system are MEMS fabricated.

20. An imaging system comprising:
an array of modules; and
wherein each module comprises:
a sub-array of at least one detector; and
a lens moveable relative to the sub-array having a focal point positioned proximate to the sub-array.

21. The system of claim 20, wherein each module further comprises a position actuator connected to the lens.

22. The system of claim 20, wherein:
each module of the array of modules has a lens with a position displacement; and
the position displacements of the lenses of the modules vary among the modules.

23. The system of claim 20, wherein some of the lenses of the array of modules have lateral displacements to achieve particular beam patterns for the system.

24. The system of claim 20, wherein each module further comprises light-blocking baffles between each module and neighboring modules.

25. The system of claim 21, each module further comprises interface electronics connected to the sub-array of detectors and the position actuator.

26. The system of claim 25, further comprising a computer connected to the interface electronics of each module.

27. They system of claim 21, wherein:
each module of the array of modules has a lens with a position displacement;
the position displacements of the lenses of the modules vary among the modules; and
the imaging system is reconfigurable by a computer which sends signals to the position actuator of each module to adjust the position displacement of the lens.

28. The system of claim 22, wherein the position displacement provides beam steering of the module.

29. The system of claim 28, wherein the beam steering of the array of modules provides adjustment of field-of-view and resolution of the imaging system.

30. The system of claim 20, wherein the array of modules provides integrated compound imaging.

31. An imaging system comprising:
an array of detectors; and
a lens proximate to the array; and
wherein the lens is laterally moveable.

32. The system of claim 31, further comprising an actuator connected to the lens.

33. The system of claim 31, wherein the lens has a plurality of lateral positions relative to the array.

34. The system of claim 32, wherein:
a computer may send signals to the actuator to move the lens to each of the plurality of lateral positions; and
the array of detectors may send an image to the computer for each of the plurality of lateral positions of the lens.

35. The system of claim 33, wherein the images of the plurality of lateral positions are processed into a resultant image.

36. The system of claim 31, further comprising:
a plurality of image units; and
wherein each imaging unit comprises:
an array of detectors; and
a lens proximate to the array of detectors.

37. An imaging method comprising:
providing an array of detectors;
situating a lens proximate to the array of detectors;
moving the lens to each of a plurality of positions;
processing each image from the array of detectors for each of the plurality of positions into a resultant image.

38. The imaging method of claim 37, repeating claim 37 for other arrays of detectors lenses proximate to the arrays of detectors, respectively.
